(19) United States
(12) Patent Application Publication
(10) Pub. No.: US 2014/0114875 A1
(43) Pub. Date: Apr. 24, 2014

(54) METHODS AND SYSTEMS FOR THE SECURE SALE OF TANGIBLE GOODS

(71) Applicant: SWAPBOX INC., San Francisco, CA (US)

(72) Inventors: Neel MURTHY, San Francisco, CA (US); Nitin SHANTHARAM, San Francisco, CA (US)

(73) Assignee: SWAPBOX INC., San Francisco, CA (US)

(21) Appl. No.: 14/061,001

(22) Filed: Oct. 23, 2013

Related U.S. Application Data
(60) Provisional application No. 61/717,233, filed on Oct. 23, 2012.

(51) Int. Cl. G06Q 10/08; G07C 9/00

(52) U.S. Cl. CPC G06Q 10/0836; G07C 9/00896
USPC 705/339

(57) ABSTRACT

These inventions relate generally to methods and systems for consummating asynchronous transactions between users. An “asynchronous transaction” is a transaction that involves an exchange of goods which does not require the seller, on the one hand, and the purchaser or renter, on the other hand, to schedule a time to meet to physically transfer the item to be delivered. The disclosed systems include an automated storage device in communication with a central server, the automated storage device comprising a plurality of locked storage compartments. A seller may deposit an item in a locked storage compartment for a purchaser or renter to pick up at a later time. The disclosure also includes methods to authenticate the seller and the purchaser or renter prior to granting access to the locked storage compartment, as well as methods to resolve disputes that may arise between the seller and the purchaser or renter.

This application claims the benefit of priority to U.S. Provisional Application No. 61/717,233 filed Oct. 23, 2012, which is hereby incorporated by reference in its entirety.

### BACKGROUND OF THE INVENTION

The present invention generally relates to improvements in apparatus and methods involving sale/purchase, rental or other transactions of tangible goods between users in an online marketplace.

### BACKGROUND OF THE INVENTION

Rather than relying on word of mouth, informal social networks or advertising, individual consumers and businesses seeking to buy, sell, rent or consummate other transactions involving tangible goods are increasingly turning to the Internet to find other interested counterparts. Online marketplaces have evolved to allow consumers and businesses to efficiently search for and screen interested parties by type of product or service offered, location, customer reviews and transaction history. Examples of such marketplaces include Craigslist, eBay and Amazon.com. However, existing online marketplaces still require transacting parties to either meet in-person to consummate a transaction, or require the seller to mail, courier, or otherwise cause the item to be delivered to the purchaser or renter.

### BRIEF DESCRIPTION OF THE DRAWINGS

FIG. 1 is a perspective view of an example locker system utilized by the system and method of the present invention.

FIG. 2 is a schematic frontal view of an example locker system utilized by the system and method of the present invention.

FIG. 3 is a perspective view of an example locker system utilized by the system and method of the present invention in a “linear” configuration.

FIG. 4 is a perspective view of an example locker system utilized by the system and method of the present invention in a “staggered” configuration.

FIG. 5 is a close-up view of the user interface area of an example locker system utilized by the system and method of the present invention.

FIG. 6 is cut-away view of a control bay area and a perspective view of a control bay shelf of an example locker system utilized by the system and method of the present invention.

FIG. 7 is a close-up view of the components mounted to the bottom left corner of the inside surface of a locker door in an example locker system utilized by the system and method of the present invention.

FIG. 8 is a diagram illustrating one possible placement of cameras within a locker of an example locker system utilized by the system and method of the present invention.

FIG. 9 is a block diagram illustrating the electrical and control components of an example locker system utilized by the system and method of the present invention.

FIG. 10 is a block diagram illustrating how an example locker system interacts with an example online network to facilitate an asynchronous transaction.

FIG. 11 is a flow-chart depicting an example procedure for a seller to deposit an item with a locker system utilized by the system and method of the present invention.

FIG. 12 is a flow-chart depicting an example procedure for a purchaser to pick up an item from a locker system utilized by the system and method of the present invention.

FIG. 13 is a flow-chart depicting an example procedure for resolving disputes regarding transactions utilized by the system and method of the present invention.

### SUMMARY OF THE INVENTION

In one embodiment, the present invention is directed at an automated storage device that communicates with a central server via a wireless network. This automated storage device may comprise a communication device for communicating with the central server via the wireless network, one or more storage compartments each equipped with a lock, and a processor connected to said locks and to said communication device. The processor may be configured to open at least one of the locks based on information received by the communication device from the central server.

In another embodiment, the present invention is directed at a method for consummating an asynchronous transaction between users of an online marketplace. The method comprises the steps of receiving, at a central server, information from a selling user regarding an item that the selling user wishes to sell, publishing the received information on an online marketplace, receiving at the central server an offer from a purchasing user to purchase the item, and selecting an automated storage device from among a plurality of automated storage devices. The method further comprises the steps of providing information regarding the selected automated storage device to the selling user and the purchasing user, sending instructions from the central server to cause the selected automated storage device to provide access to at least one storage compartment to the selling user, and sending instructions from the central server to cause the automated storage device to provide access to the storage compartment to the purchasing user.

### DETAILED DESCRIPTION OF THE INVENTION

This disclosure relates generally to a method and system for consummating asynchronous transactions of goods between users of an online marketplace. An “asynchronous transaction,” as referred to in this specification and the appended claims, is a transaction that involves an exchange of goods which does not require the seller, on the one hand, and the purchaser or renter, on the other hand, to schedule a time to meet to physically transfer the item to be delivered to the purchaser or renter.

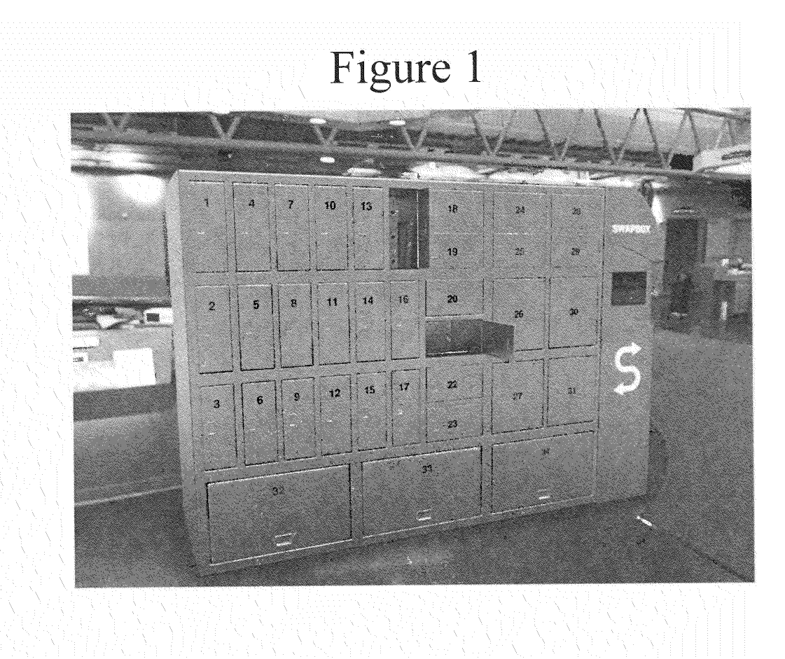

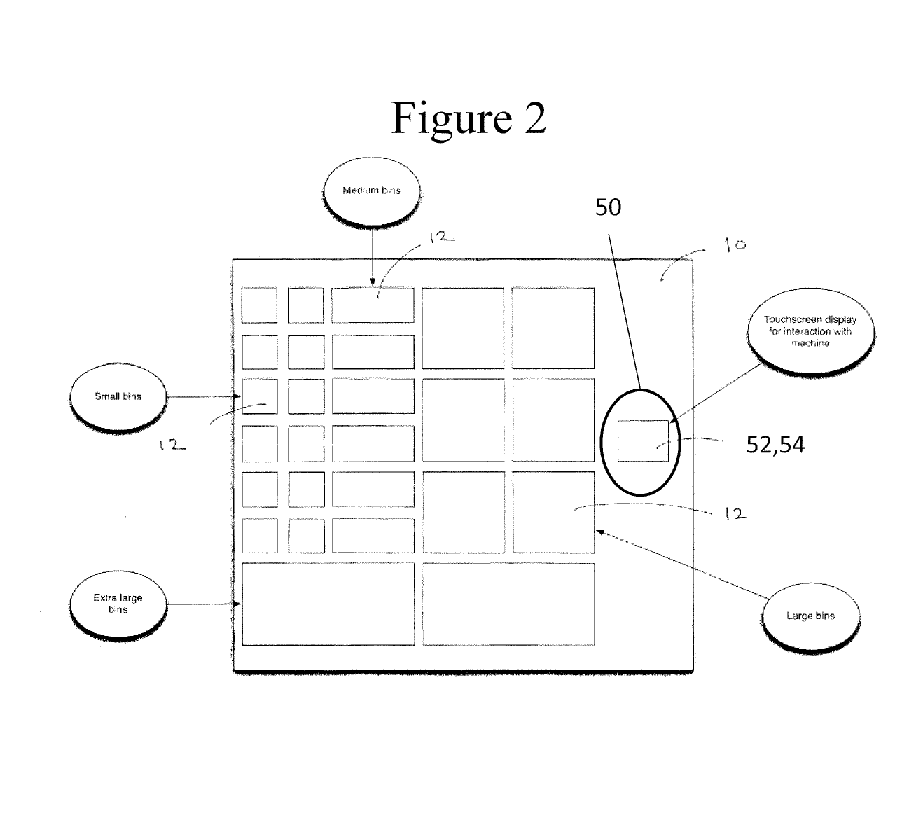

FIG. 1 is an illustration of an example automated storage device 10 in a public space. FIG. 2 is a schematic diagram of the same example automated storage device 10. The automated storage device 10 is capable of accepting, storing, and disbursing objects of differing sizes and types.

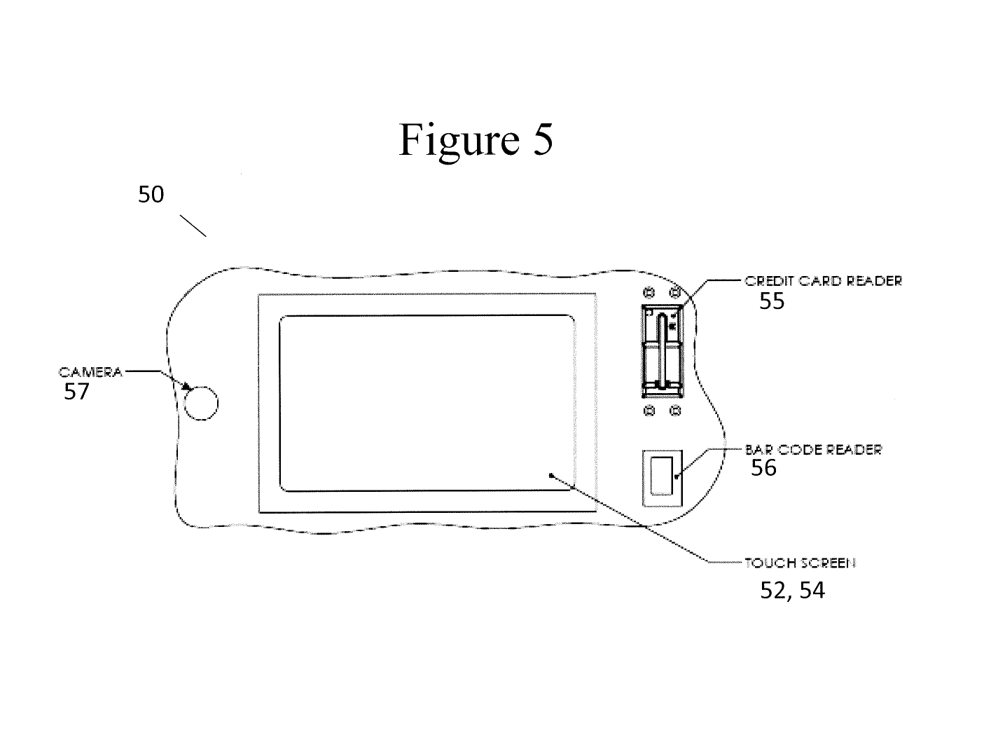

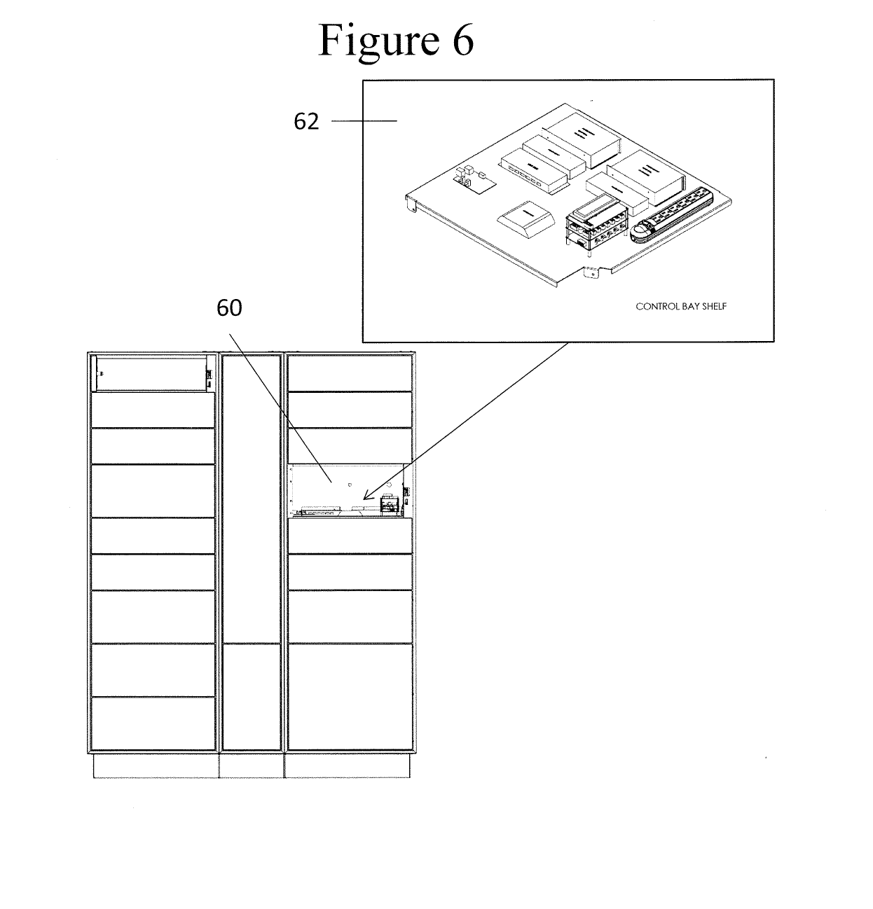

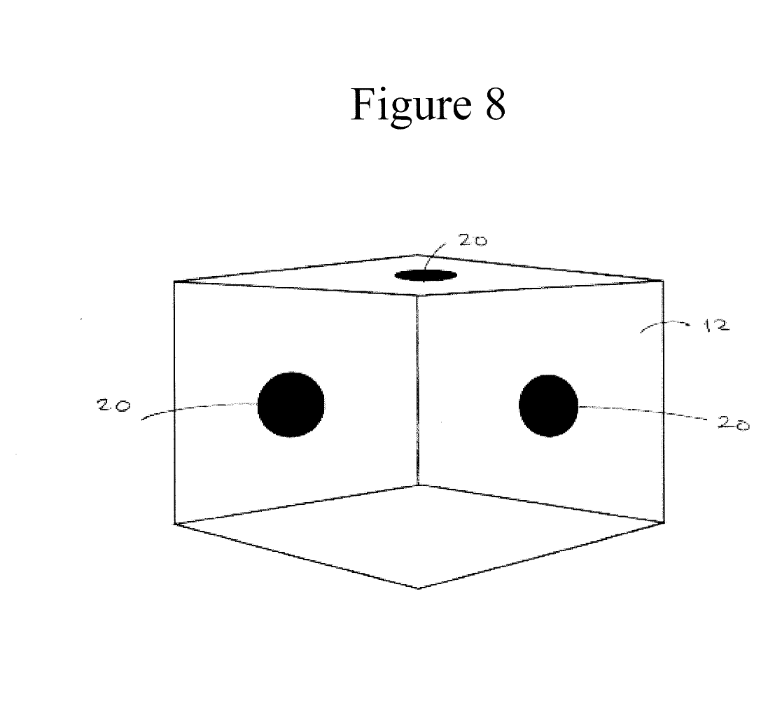

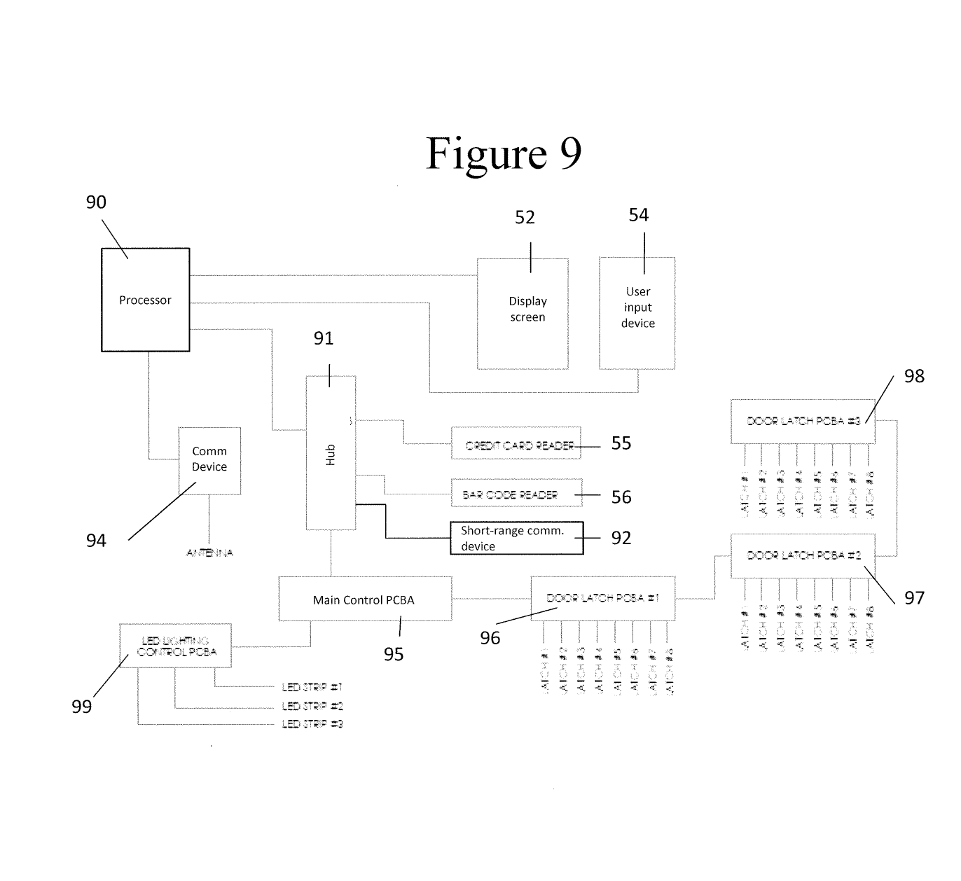

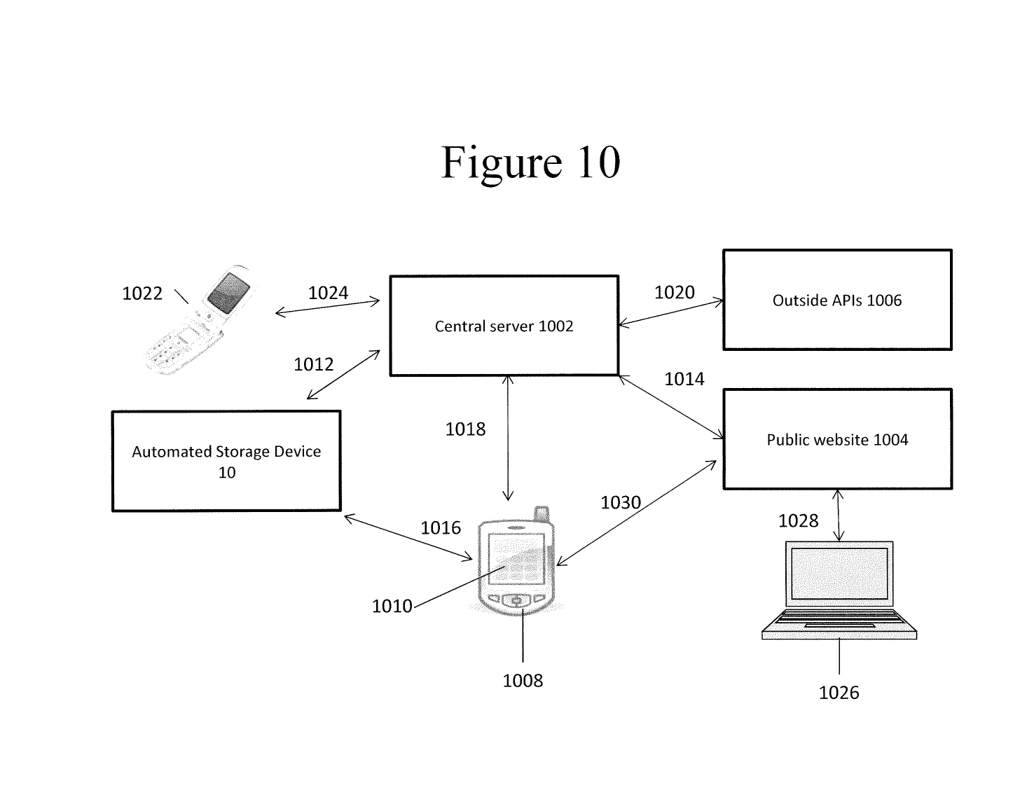

The automated storage device 10 may include a number of locked storage compartments 12 of differing sizes, each of which may be configured to accommodate objects of different sizes, a camera or cameras 20 capable of taking pictures of items placed inside said storage compartments 12 (see FIG. 8), and an internal alarm system to deter against theft (not shown). The automated storage device 10 may also include a user interface area 50 comprising a display screen 52 and user input device 54 (the display screen 52 and user input device 54 may be integrated into one touch-sensitive display) which shows transaction details and allows the user to input a personal identification number (“PIN”), as well as an optional camera 57 located external to any storage compartment 12 (see FIG. 5). Optional camera 57 may be configured to take pictures of items being deposited or picked up, or pictures of the person interacting with the user interface. Furthermore, the automated storage device 10 may also include a communication device 94 (see FIG. 9) in communication with a central server 1002 via a wireless network or some other medium 1012 (see FIG. 10), a control bay shelf 62 (see FIG. 6) containing a processor 90 (see FIG. 9), and a short-range communication device 92 (see FIG. 9) that communicates directly with a user's mobile device 1008 rather than through the central server 1002 (see FIG. 10).

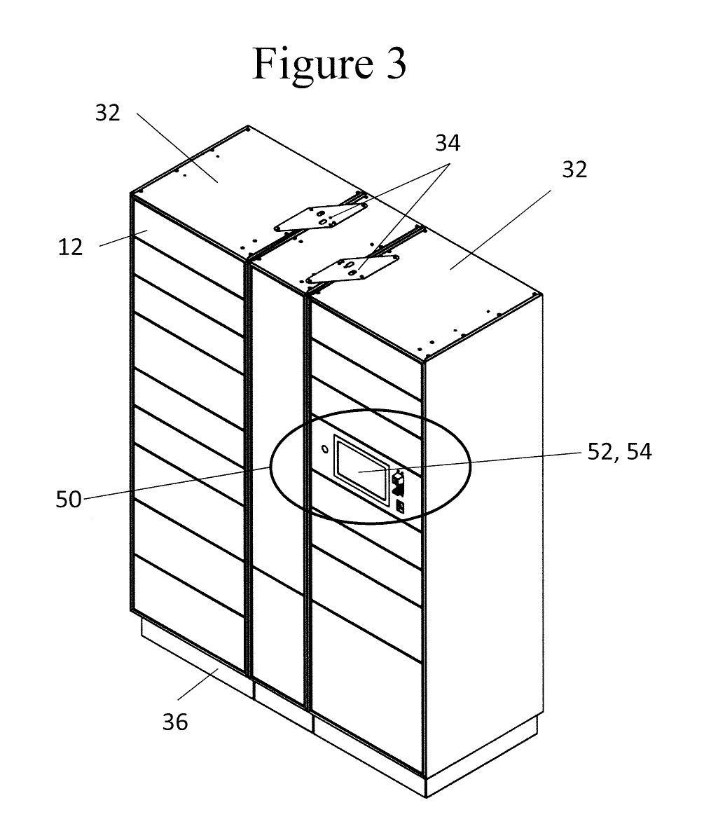

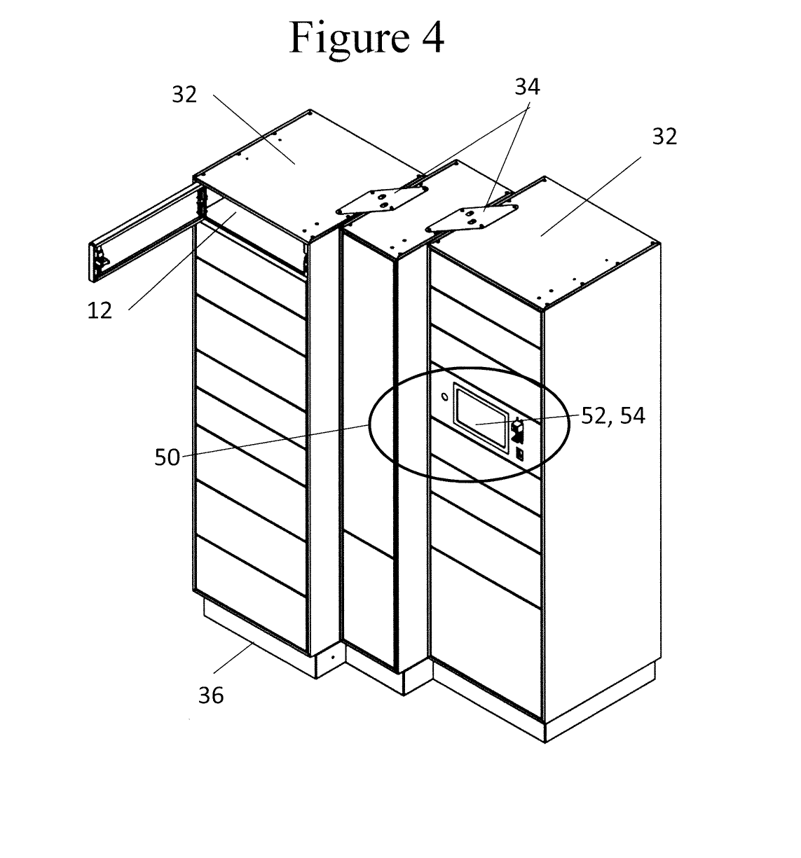

FIGS. 3 and 4 are schematic diagrams depicting an alternative embodiment of an automated storage device that comprises modular components 32 which may be combined to fit a variety of spaces. FIG. 3 depicts an example of an automated storage device in a “linear” configuration, in which each module 32 is arranged in a straight line relative to each other. FIG. 4 depicts an example of an automated storage device in a “staggered” configuration, in which each module 32 is slightly offset from each other. In both FIG. 3 and FIG. 4, fasteners 34 attach the modular components to each other. More modular components may be attached to either end of the automated storage devices depicted in FIG. 3 and FIG. 4, as needed. This alternative embodiment of an automated storage device also features a base 36 on which modular components 32 rest. The base 36 may be constructed from metal tubes through which control and power wires may pass to connect the modular components 32 to each other. The base 36 may also function to elevate modular components 32 off the ground to prevent water from seeping into the storage compartments 12, and also to protect the control and power wires from water damage. Finally, base 36 may be composed of multiple modular components which may be combined to fit a variety of spaces. FIG. 4 depicts an example of a storage compartment 12 in an open and unlocked position.

FIG. 5 is a schematic diagram of an example user interface area 50. As described above, user interface area 50 includes at least a display screen 52 and an user input device 54 (which may be integrated into one touch-sensitive display). In addition, user interface area 50 may include a credit card reader 55 configured to read a user's credit card information, a bar code reader 56 configured to scan a product's bar code, and a camera 57 configured to take pictures of items being deposited or collected from the automated storage device 10, or to take pictures of the person interacting with the user interface.

FIG. 6 is a schematic diagram of the front of an example automated storage device with the panel containing the user interface area 50 removed, thereby exposing the control bay area 60 behind it. The user interface area may be unlocked and removed by inserting a key into a keyhole (not shown) mounted on the side or on the back of the automated storage device. The control bay area 60 contains the control bay shelf 62, which may be a pre-manufactured printed circuit board. Control bay shelf 62 is configured to be easily disconnected and replaced for ease of maintenance and repair. The components and functions of control bay shelf 62 will be discussed in more detail in relation to FIG. 9.

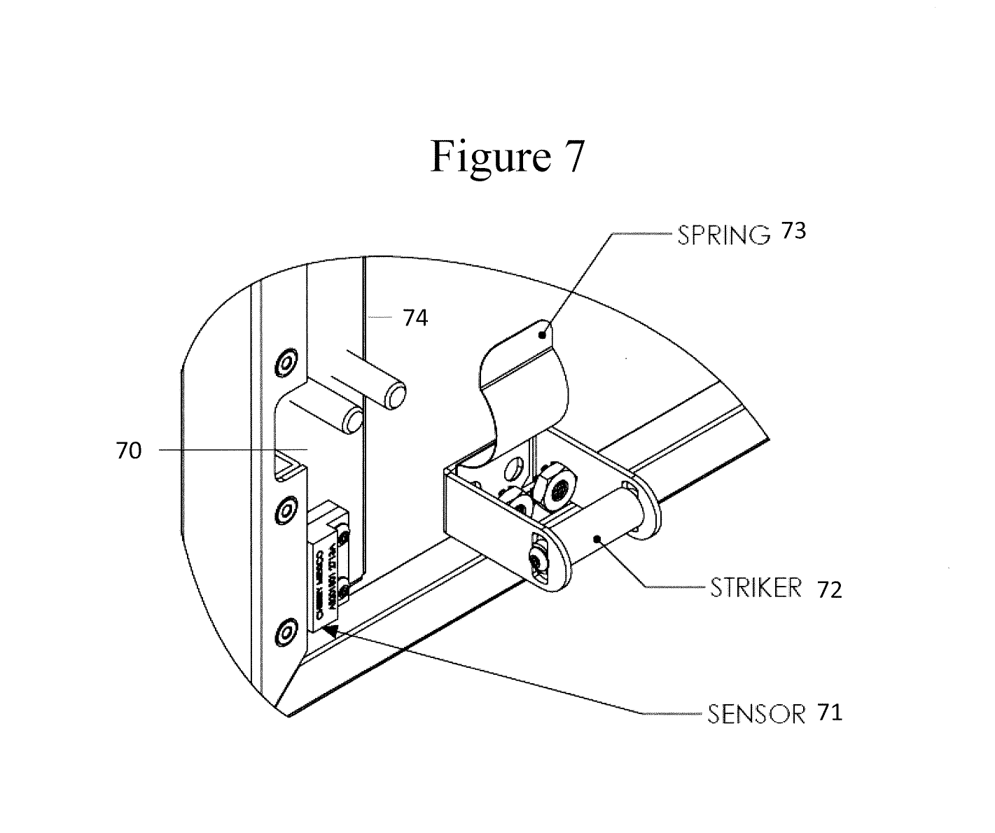

FIG. 7 is a close-up schematic diagram of the bottom left corner of the inside surface of a door 70 to a storage compartment 12, according to some embodiments. On the inside of door 70 is mounted a sensor 71, a striker 72 and a spring 73. Striker 71 may be configured to be latched onto by a latch (not shown) located on an opposing surface of storage compartment 12. The latch may be configured to be switched between an “open” and a “locked” position. When the door 70 is closed, the latch may be switched into the “locked” position, which causes the latch to hook around striker 71 and thereby secure the door 70 in a locked position. Spring 73 is configured to push door 70 into an open position if the latch is then switched into an “open” position. Any damping method or component known in the art may be used to prevent door 70 from opening too energetically. Sensor 71 may be a magnetic sensor which is configured to sense the presence of a magnet or piece of metal (not shown) located on the opposing surface of storage compartment 12 when door 70 is closed. If the magnet or piece of metal is sensed by sensor 71, sensor 71 will output a signal via wire 74 to processor 90, indicating that door 70 is closed. In an alternative, no special piece of metal need be provided on the opposing surface, as the sensor 71 may be configured to sense the metal frame of storage compartment 12.

There may be a situation where the latch is switched into the locked position while door 70 is still open, which would prevent door 70 from closing properly. In this instance, the processor 90 may detect this error condition by sensing that (i) the latch is switched into the locked position, while (ii) the signal from sensor 71 (or lack thereof) indicates that door 70 is still open. The processor 90 may then direct the latch to switch into the open position to allow door 70 to close properly.

FIG. 8 is a diagram showing the possible placements of an optional internal camera or cameras 20 within a storage compartment 12. These cameras may be configured to take pictures of items placed within storage compartment 12, potentially from more than one angle. For example, separate cameras 20 may be placed on three angles: on top of the item, behind the item, and to the side. Alternatively, one or more cameras 20 may be placed on an actuating arm (not shown) that moves around the compartment to get a panoramic view of the item.

FIG. 9 is a block diagram showing the electrical and control components of an example automated storage device 10. These components include a processor 90, a display screen 52 and user input device 54, a communication device 94 (which may comprise a 3G router connected to an optional antenna), a credit card reader 55, bar code reader 56, short-range communication device 92 (which may comprise a WiFi, Bluetooth or NFC communication module), and a main control printed circuit board assembly (PCBA) 95 connected to the processor 90 via a hub 91 (which may comprise a Universal Serial Bus (USB) hub), door latch PCBA's 96, 97 and 98 connected in series with main control PCBA 95, and a LED lighting control PCBA 99 connected with the main control PCBA 95. Any or all of processor 90, communication device 94, hub 91, main control PCBA 95, LED lighting control PCBA 99 and door latch PCBAs 96, 97 and 98 may be located on control bay shelf 62. For example, the main control PCBA 95, door latch PCBAs 96, 97, and 98, and LED lighting control PCBA 99 may be located on control bay shelf 62, which may be connected via easily detachable connections to other components located within automated storage device 10, such as hub 91 and processor 90. In this instance, the components located on control bay shelf 62 may take voltage and/or amperage values from latches and LED strips and translate them into conditions (i.e., open/closed, on/off) for use by the processor 90. Door latch PCBAs 96, 97 and 98 may each control and receive feedback information from a plurality of latches, wherein each latch may correspond to a separate storage compartment 12. LED lighting control PCBA 99 may be configured to control and receive feedback information from a plurality of LED lighting strips located within multiple storage compartments 12. The processor is configured to receive, process, and store in internal memory (not shown) information from communication device 94, user input device 54, credit card reader 55, bar code reader 56, short-range communication device 92, and door latch PCBAs 96, 97, and 98. The processor may also issue instructions to various components, for example, data to display on display screen 52, or instructions to door latch PCBAs 96, 97, 98 to open or lock a specific door latch.

FIG. 10 is a block diagram illustrating how an example automated storage device 10 interacts with an online network to facilitate an asynchronous transaction. An example online network may include a server 1002, a public website 1004, outside APIs 1006, a mobile-device-based application 1010 running on a mobile device 1008 (e.g., a smartphone or a tablet), a computer 1026, and a mobile phone 1022. A multitude of automated storage devices 10 may be placed in selected public areas to allow users convenient access, as illustrated in FIG. 1. These automated storage devices 10 are in remote communication with a central server 1002 via a communication channel 1012 hosted on a wireless or wired network.

Users of the disclosed system may receive information from or send information to the automated storage device 10 using several methods. First, users may input and receive information directly from the automated storage device using the display screen 52 and user input device 54, as discussed above. Second, users may access the server 1002 via a website 1004 using a computer 1026 via a communication channel 1028 hosted on the Internet. Alternatively, users may access the website 1004 using their mobile device 1008 via a communication channel 1030 hosted on a wireless network. The website 1004 communicates with the server 1002 via a communication channel 1014, and the server 1002 may then relay data or issue instructions to and from automated storage device 10 via channel 1012. Third, users may access the server 1002 via a mobile-device-based application 1010 running on a mobile device 1008, which communicates with the server via a communication channel 1018 hosted on a wireless network; the server 1002 then relays data or issues instructions to and from automated storage device 10 via channel 1012. Fourth, users may send and receive text messages using a mobile phone 1022 connected to the central server 1002 via a communication channel 1024 hosted on a wireless cell phone network; the server 1002 then relays data or issues instructions to and from automated storage device 10 via channel 1012. Finally, users may use a mobile-device-based application 1010 running on a mobile-device 1008 to communicate directly with an automated storage device 10 via a short-range communication channel 1016 (e.g., Bluetooth, WiFi or NFC).

Information passing between server 1002 and website 1004 and/or the mobile-device-based application 1010 may include transmissions and/or verifications of login information, transaction data (e.g., purchases, offers, rental requests, etc.), credit/debit card information, and listing information (e.g., new listings, edited listings, product images). Information passing between server 1002 and automated storage device 10 may include all of the above types of information, as well as transmission/verification of successful transaction data (e.g., drop-offs/pickups), current inventory of items, commands of when to open a particular compartment and/or release an item, and other analytical data.

The central server 1002 is also in communication with outside APIs, such as Facebook, Amazon or Google, via a communication channel 1020 hosted on the Internet. The central server 1002 may use information pulled from these outside APIs for verification purposes (e.g., to validate a credit card number on file, or to verify login data), and to obtain seller/buyer information. The server 1002 may also use outside APIs to provide information about products, e.g., bar code information, photographs, prices, product features and capabilities, etc.

In one embodiment, the disclosed system may be used to facilitate the sale of an item from a seller to a purchaser. The seller initiates the process by accessing the website 1004 from his/her computer 1026 or by communicating directly with the server 1002 through his/her mobile device 1008 and creating an online account by inputting his/her name, location, contact information and credit or debit card information. Once the account has been created, the seller may create a listing to solicit bids for the item he/she wishes to sell.

A listing may be created in multiple alternative ways. For example, a seller may use his mobile device 1008 in communication with the central server 1002 (either via a public website 1004 or via a mobile-device based application 1010 and communication link 1018) to select the category for the item he/she wishes to sell, which then brings up a listing flow. The seller may use the camera on his/her mobile device 1008 to take pictures of the object. Then, the seller either scans the item's barcode (if it has one) or fills out information by entering it into text boxes, including the item name, price and condition. If the barcode is scanned, the central server 1002 will pre-populate all the fields on the seller's device. Alternatively, the seller may use the bar code reader 56 on an automated storage device 10 to scan a barcode. Once the seller reviews and confirms the pre-populated fields are correct, the seller may submit the listing. Even if the barcode is not scanned, central server 1002 will use database and matching algorithms (using, for example, API feeds 1006 from Google shopping, Amazon, and other data) to auto-complete as many fields in the item description as possible. Central server 1002 may also suggest a price estimate to the seller based on weighted averages of location, demographic information, item type and condition. The weights used can be adjusted manually by the seller to suit his/her preferences. In addition, central server 1002 may also automatically adjust the weights as it learns more about the seller's preferences through repeated transactions.

A listing may also be created by accessing a website 1004 from the seller's computer 1026. The process is similar to the one described above. However, instead of taking pictures with the camera on the seller's mobile device 1008, the seller must upload a picture of the item. Alternatively, the seller may also use a stock photo provided by the website 1004 in order to avoid uploading the image. The central server 1002 provides stock photos from sites such as Google shopping, Amazon, and eBay based on the item name, which may be drawn from outside API feeds 1006.

Other users who have created similar accounts may then browse and search through these listings to locate an item they wish to purchase and submit offers. If an offer is made, the central server 1002 will notify the seller to which it pertains using emails, texts or other notification means. The seller may then accept or reject the offer. If the offer is accepted, the purchaser is notified. At this point, the central server 1002 attempts to locate the physical locations of both the purchaser and the seller. If either the purchaser or the seller is using a mobile device 1008, the central server 1002 will simply pull the latitude and longitude from the device. If either the purchaser or the seller is using a personal computer 1026, the central server 1002 will use a paid service to convert his/her internet protocol (IP) address into a latitude and longitude. Once the physical locations of both the purchaser and seller have been determined, the central server 1002 will provide a list of nearby automated storage devices 10, with preference given to the location that is most optimal for both parties based on traffic or distance. Alternatively, the seller or the purchaser may select, with the other's consent, an automated storage device 10 at another location.

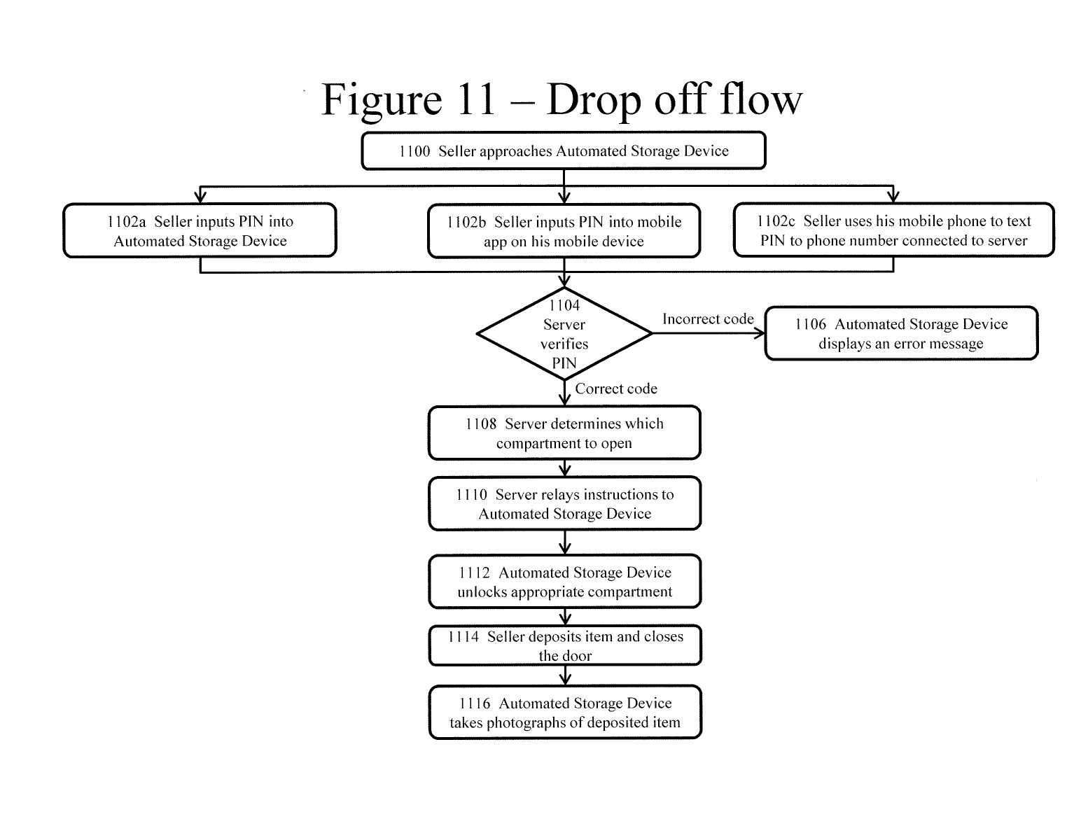

FIG. 11 shows the procedure for a seller to deposit an item with an automated storage device 10. The seller authenticates his/her identity by providing a personal identification number (“PIN”) associated with his/her account or with this particular transaction. The seller may do so by using display screen 52 and user input device 54 of the automated storage device 10 in step 1102a. Alternatively, the seller may use a mobile application on his/her mobile device 1008 to interact with the central server 1002 or directly with the optional short-range communication device 92 to provide his/her PIN via a short-range communication link (e.g., WiFi, Bluetooth, or Near Field Communication (NFC)) in step 1102b. In yet another alternative, the seller may use his/her mobile phone to text his/her PIN to a phone number associated with the central server 1002 in step 1102c. If the PIN is incorrect, the central server 1002 will instruct the automated storage device 10 to display an error message in step 1106. However, if the central server 1002 verifies the PIN in step 1104, the server 1002 uses an algorithm in step 1108 to determine which compartment 12 would be most suitable based on the dimensions of the item being sold, which server 1002 determines from listings such as Google Shopping, Amazon, eBay and other data stored on the server 1002 or provided by the seller, and which storage compartments are available, which server 1002 determines by communicating with automated storage device 10. Once the appropriate compartment 12 has been identified, the server 1002 instructs the automated storage device 10 to open the appropriate compartment, which the automated storage device 10 does in step 1112.

Once the seller deposits the item into the open storage compartment 12 and closes the door in step 1114, the automated storage device 10 will signal the central server 1002 that the item has been dropped off and locks the door to storage compartment 12. The server 1002 then notifies the purchaser that the item is ready for pickup through email, text or other notification method depending on the purchaser's preference.

In some instances, the automated storage device 10 may use its internal cameras 20 (if present) to take pictures of the deposited item from varying angles immediately after it is deposited in step 1116. Alternatively, the automated storage device 10 may use its external camera 57 (if present) to take pictures of the deposited item immediately before it is deposited. The pictures are sent to the central server 1002 and forwarded to the purchaser to allow the purchaser to verify the condition of the item he/she is buying. The pictures are also stored in the central server 1002 as a record of the item's condition at the time of deposit in case of a future dispute between the purchaser and the seller. Central server 1002 may also run preliminary checks on images of the deposited items to verify that, for example, no illegal items were deposited.

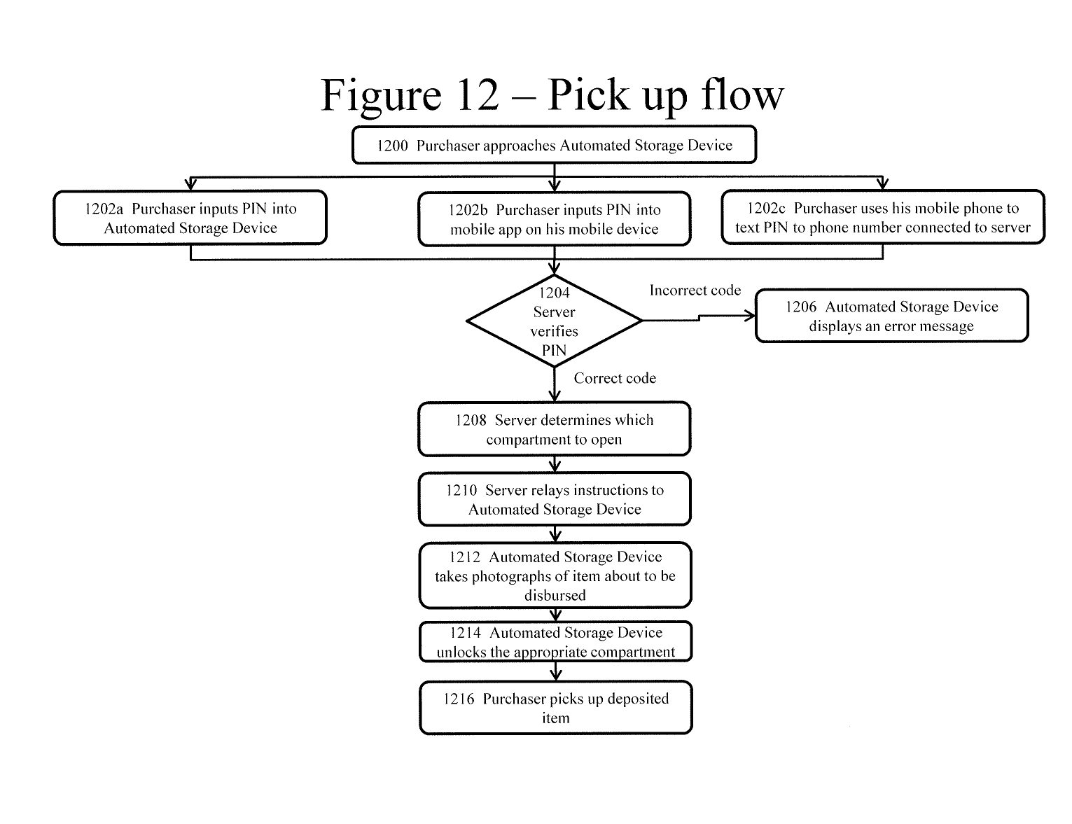

FIG. 12 shows the procedure for a purchaser to collect an item. Once the purchaser has been notified that the item is ready for pickup, the purchaser goes to the automated storage device 10 identified by the central server 1002, and opens the appropriate compartment 12 using an identical procedure: the purchaser may use a mobile application on a mobile device (step 1202b), input a PIN on the storage device's user input device 54 (step 1202a), or text a pre-determined code to a phone number associated with the central server 1002 (step 1202c). If the PIN is incorrect, the central server 1002 will instruct the automated storage device 10 to display an error message in step 1206. However, if the central server 1002 verifies the PIN in step 1204, the server 1002 will retrieve from memory the compartment the seller had placed the item into in step 1208, and instruct the automated storage device 10 to open the appropriate compartment in step 1210. In some embodiments, the automated storage device may use its internal cameras 20 (if present) in optional step 1212 to take pictures of the deposited item from varying angles immediately before the compartment door to a storage compartment 12 is opened and the item is picked up. Alternatively, the automated storage device may use its external camera 57 (if present) to take pictures of the deposited item immediately after the compartment door is opened. The pictures are sent to the central server 1002 and stored there as a record of the item's condition at the time of pickup in case of a future dispute between the purchaser and the seller. The automated storage device then opens the appropriate compartment in step 1214. When the compartment opens, the purchaser picks up the deposited item in step 1216 and the transaction is complete. The central server may optionally charge the purchaser and credit the seller by, for example, using both users' registered credit or debit card information that has previously been provided to the central server 1002.

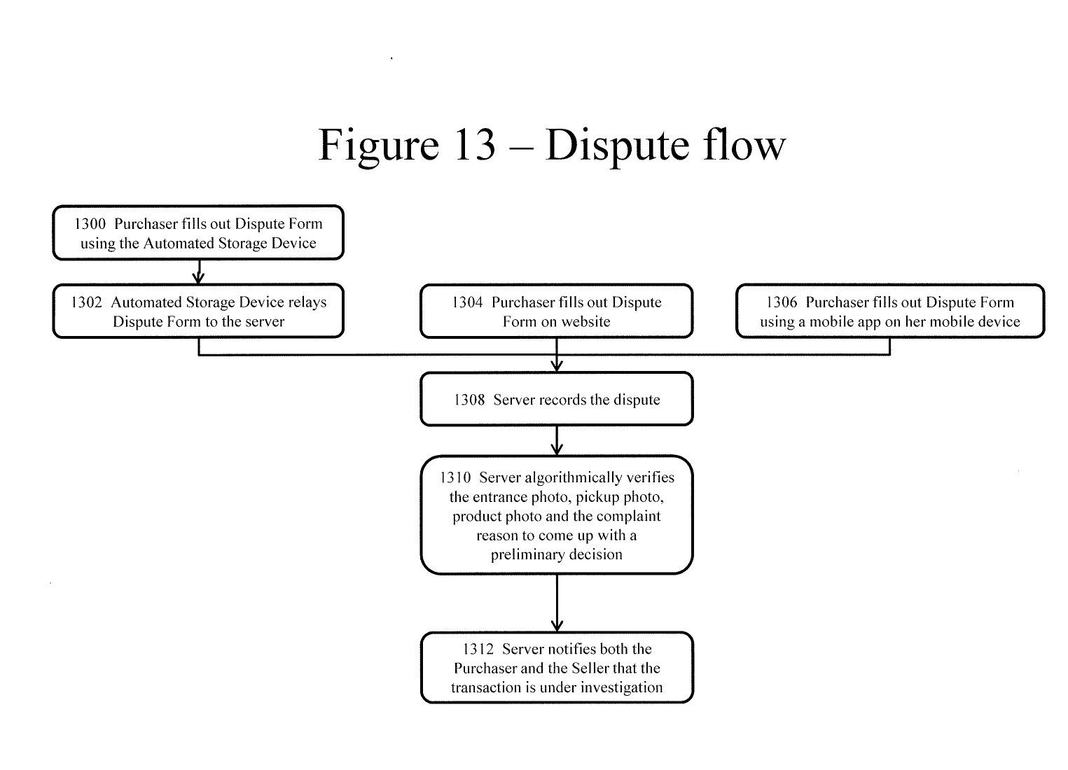

FIG. 13 shows the procedure for resolving a dispute between the purchaser and the seller. If the purchaser is not satisfied with the condition of the item, the purchaser may initiate a dispute process by submitting a dispute form through a mobile application on a mobile device in step 1306, through a computer via a website in step 1304, or through the display screen 52 and user input device 54 on the automated storage device 10 in step 1300 (in this instance, the automated storage device 10 would forward the dispute information to the server 1002 in step 1302). Once the central server 1002 receives the dispute form, the server 1002 then notifies the seller that a dispute has been lodged and opens a formal dispute resolution process in step 1308. If deposit and pickup photos of the item were taken, in step 1310 the server 1002 may also algorithmically compare the photos, consider the complaint reason, and come up with a preliminary decision regarding who is at fault. This can be done by comparing the pixel representations of each image to find which regions are different, and forwarding the images to a human operator for inspection if the differences between the images exceed a certain threshold. In step 1312, the parties are notified that the transaction is under investigation, and may also inform the parties of a preliminary decision based on the comparison of the deposit and pickup photos.

In another embodiment of the invention, the disclosed method and system may be used to facilitate the rental of an item from a seller to a renter. A seller wishing to offer an item for rent initiates the process by creating an online account as disclosed above. Once the account has been created, the seller may create a listing to solicit bids for the item he wishes to rent. This listing may include photographs and descriptions of the item, location of the item, desired amount and frequency of rental payments, and any other pertinent information or desired rental terms. Alternatively, the seller may use a mobile application installed on a mobile device to photograph the item to be rented and create a listing.

Other users who have created similar accounts may then browse and search through these listings to locate an item they wish to rent and submit offers. If an offer is made, the seller is notified of the offer and may either accept or reject the offer. If the offer is accepted, the renter is notified. The central server 1002 then compares the seller's location with the renter's location and uses the location algorithm disclosed above to determine the automated storage devices closest to both users. The central server 1002 then provides both users with a list of all such storage devices 10, with preference given to the location that is most optimal for both parties based on traffic or distance. Alternatively, the seller or the renter may select, with the other's consent, an automated storage device 10 at another location.

The seller deposits and the renter picks up the item using the same procedures as disclosed above. At pre-determined intervals of time (e.g., daily, weekly, monthly, etc.) previously agreed-upon between the seller and the renter, the central server 1002 charges the renter and credits the seller by, for example, using both users' registered credit or debit card information.

When the rental term has expired, the renter returns the item by depositing it in an automated storage device 10. The return system is the exact same as the dropoff system. The renter is notified by the central server 1002 through emails, texts or some other notification method that the rental term has expired, and uses either the user input device 52, his mobile device 1008, or his mobile phone 1022 to provide his PIN. Once the central server 1002 verifies his PIN, the central server determines which compartment 12 to open based on the dimensions of the item.

In some embodiments, the automated storage device 10 may use its internal cameras 20 to take pictures of the returned item from varying angles immediately after the item is deposited. Alternatively, the automated storage device 10 may use its external camera 57 to take pictures of the returned item immediately before the item is deposited. The pictures are sent to the central server 1002 and forwarded to the seller to allow him to verify the condition of the item. The pictures are also stored in the central server 1002 as a record of the item's condition at the time of deposit in case of a future dispute between the seller and the renter.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. An automated storage system that communicates with a central server via a network, said automated storage system comprising:
a communication device for communicating with the central server via the network; and
one or more storage compartments each equipped with a lock;
wherein the system is responsive to information received by the communication device from the central server and is configured to open at least one of the locks based on the information.

2. The automated storage system of claim 1 further comprising a user input device wherein the system is configured to open at least one of the locks based on authentication information provided by a user via the user input device.

3. The automated storage system of claim 2 wherein the system is configured to send the authentication information to the central server, and to receive a verification of the authentication information from the central server.

4. The automated storage system of claim 1 further comprising a camera capable of taking pictures of items placed inside at least one of the storage compartments.

5. The automated storage system of claim 4 wherein the system is configured to transmit pictures taken by said camera to the central server.

6. The automated storage system of claim 5 further comprising an alarm system to deter against theft.

7. The automated storage system of claim 1 further comprising a short-range communication device that communicates directly with a user's personal mobile device.

8. The automated storage system of claim 7 wherein the system is configured to open at least one of the locks based on authentication information provided by the user's personal mobile device via the short-range communication device.

9. The automated storage system of claim 8 wherein the system is further configured to send the authentication information to the central server, and to receive a verification of the authentication information from the central server.

10. The automated storage device of claim 1 wherein the one or more storage compartments comprise multiple storage compartments which are of different volumes, and are stationary and connected together in a two-dimensional array.

11. A method for consummating an asynchronous transaction between users of an online marketplace, comprising the steps of:
receiving, at a central server, information from a selling user regarding an item that the selling user wishes to sell;
publishing the received information on an online marketplace;
receiving, at the central server, an offer from a purchasing user to purchase the item;
selecting an automated storage device from among a plurality of automated storage devices;
providing information regarding the selected automated storage device to the selling user and the purchasing user;
sending instructions from the central server to cause the selected automated storage device to provide access to at least one selected storage compartment to the selling user; and
sending instructions from the central server to cause the selected automated storage device to provide access to the selected storage compartment to the purchasing user.

12. The method of claim 11, further comprising:
determining the physical locations of the selling user and the purchasing user, wherein the selection of the automated storage device is based on the physical locations of the selling user and the purchasing user.

13. The method of claim 11, wherein the selection of the automated storage device is based on instructions received from at least one of the selling user and the purchasing user.

14. The method of claim 11 wherein the purchasing user is provided access to the storage compartment containing the item only if the automated storage device receives authentication information from the purchasing user.

15. The method of claim 14, wherein the automated storage device receives the authentication information via a user input device.

16. The method of claim 14, wherein the automated storage device receives the authentication information via the central server.

17. The method of claim 14, wherein the automated storage device receives the authentication information via a short-range communication device that communicates directly with the purchasing user's personal mobile device.

18. The method of claim 11, further comprising:
using a camera to take a picture of the item; and
sending the picture to the central server.

19. The method of claim 11, wherein the central server selects the storage compartment to which the selling user and the purchasing user is provided access based on the physical dimensions of the item.
